(19) United States
(12) Patent Application Publication
(10) Pub. No.: US 2022/0256337 A1
(43) Pub. Date: Aug. 11, 2022

(54) Methods, UE and Network Node for Handling System Information

(71) Applicant: Telefonaktiebolaget LM Ericsson (publ), Stockholm (SE)

(72) Inventors: Oscar Ohlsson, Bromma (SE); Prajwol Kumar Nakarmi, Sollentuna (SE); Vlasios Tsiatsis, Solna (SE)

(21) Appl. No.: 17/618,212

(22) PCT Filed: May 20, 2020
(86) PCT No.: PCT/SE2020/050521

§ 371 Date: Dec. 10, 2021

Related U.S. Application Data
(60) Provisional application No. 62/861,334, filed on Jun. 14, 2019.

(51) Int. Cl. H04W 12/037; H04W 48/08; H04L 9/30

(52) U.S. Cl. CPC H04W 12/037; H04L 9/30; H04W 48/08

(57) ABSTRACT

The embodiments herein relate to a method performed by a UE (103) for handling SI. The UE obtains one or multiple public keys for SI signature verification. Each of the one or multiple public keys is associated with a validity area of an access network where the public key is valid. The UE obtains a SI together with a SI signature from a network node (101) covering a cell. The SI comprises area identification information. The UE determines (103), based on the area identification information comprised in the SI, the validity area that the cell belongs to and the corresponding public key. The UE (103) verifies the SI signature using the determined corresponding public key.

### TECHNICAL FIELD

Embodiments herein relate generally to a User Equipment (UE), a method performed by the UE, a network node and a method performed by the network node. More particularly the embodiments herein relate to handling System Information (SI). The embodiments herein relate to enabling signed SI in shared networks.

### BACKGROUND

### SI in New Radio (NR)

SI is information that is repeatedly broadcast by the network and which needs to be acquired by UEs in order for them to be able to access and, in general, operate properly within the network and within a specific cell.

In NR, SI is delivered using two different mechanisms relying on two different transport channels:
A limited amount of SI, corresponding to the so-called Master-Information Block (MIB), is transmitted using the Broadcast Channels (BCH).
The main part of the SI, corresponding to different so-called System-Information Blocks (SIBs), is transmitted using the Downlink Shared Channel (DL-SCH).

The MIB contains the most essential SI parameters needed to bootstrap the UE and to obtain the rest of the SI. Unlike the SIBs, the MIB has a fixed size and the only way to add new information is use to one of the spare bits in MIB that have been reserved for future use.

The first SIB, SIB1, comprises the SI that the UE needs to know before it can access the network. SIB1 is always periodically broadcast over the entire cell area. An important task of SIB1 is to provide the information the UE needs to carry out initial random access. SIB1 also comprises scheduling information for the remaining SIBs. MIB and SIB1 together forms what is known as the Minimum SI.

The remaining SIBs, not including SIB1, is known as the Other SI and comprises the SI that a UE does not need to know before accessing the network. These SIBs can also be periodically broadcast similar to SIB1. Alternatively, these SIBs can be transmitted on demand, that is, only transmitted when explicitly requested by the UE. This implies that the network can avoid periodic broadcast of these SIBs in cells where no UE is currently camping, thereby allowing for enhanced network energy performance. Currently, at least the following SIBs are defined:
SIB2 comprises cell re-selection information, mainly related to the serving cell;
SIB3 comprises information about the serving frequency and intra-frequency neighbouring cells relevant for cell re-selection, including cell re-selection parameters common for a frequency as well as cell specific re-selection parameters;
SIB4 comprises information about other NR frequencies and inter-frequency neighbouring cells relevant for cell re-selection, including cell re-selection parameters common for a frequency as well as cell specific re-selection parameters;
SIB5 comprises information about Evolved-Universal Terrestrial Access (E-UTRA) frequencies and E-UTRA neighbouring cells relevant for cell re-selection, including cell re-selection parameters common for a frequency as well as cell specific re-selection parameters;
SIB6 comprises an Earthquake & Tsunami Warning System (ETWS) primary notification;
SIB7 comprises an ETWS secondary notification;
SIB8 comprises a Commercial Mobile Alert System (CMAS) warning notification;
SIB9 comprises information related to Global Positioning System (GPS) time and Coordinated Universal Time (UTC).

Three types of Radio Resource Control (RRC) message are used to transfer SI: the MIB message, the SIB1 message and SI messages. An SI message, of which there may be several, comprises one or more SIBs which have the same scheduling requirements, i.e. the same transmission periodicity. The mapping of SIBs into SI messages as well as the scheduling information for those SI messages is defined in SIB1.

### Signed SI in NR

Today in NR, SI is transmitted without integrity protection which means that an attacker may attempt to manipulate the SI without the UE being able to detect it. As a result, UE may use that manipulated SI and may be tricked to camp on a rogue cell leading to denial of service. The UE may also end up reporting false/incorrect information about neighbor cells to the genuine network which in turn could impact various Self-Organizing Networks (SON) functions. To mitigate this type of attacks one solution is to digitally sign the SI using public key cryptography.

Cryptography and encryption uses a private key and a public key, which may be referred to as a private/public key pair. A private/public key par comprises two uniquely related cryptographic keys, e.g. random numbers. The public key is public, i.e. it is made available to everyone via a publicly accessible repository or directory. The private key remains confidential to its respective owner. The private key and the public key are mathematically related, i.e. whatever is encrypted with a public key may only be decrypted by its corresponding private key and vice versa.

### Selective Deployment of Signed SI

One general problem with signed SI is that only a subset of the operators may choose to deploy such a solution, and the ones that do might only do so in a limited part of their network. It is also possible that only parts of the SI are signed. For example, to avoid having to re-generate the SI signature all the time, SIBs that are updated often, e.g. SIB9 which contains time information, can be excluded from the SI signature generation. The operator can inform the UE in a secure way whether a network uses signed SI or not and which parts of the SI that are covered by the SI signature.

### Supporting Large SI Signatures Using Late Detection

Ideally the SI signature should be included already in Minimum SI, i.e. MIB or SIB1, since this is the first SI that the UE acquires and it is also the only SI that is required to access the network.

Since the size of the SI signature is large it can be difficult to fit it into the Minimum SI. Using MIB is ruled out since MIB has a fixed size and the free space that is available is very limited. Also the size of SIB1 is limited in practice as cell edge UEs need to be able to decode it within the SI transmission window. The exact size limit depends on factors such as transmission power, cell size and frequency band, etc. but is typically around 1000 bits. Since SIB1 also comprises other information there may not be enough space left to fit the SI signature. SIB1 is also time critical and to reduce the acquisition time it should preferably be as small as possible.

One way to solve the size problem is to transmit the SI signature in a separate SIB. However, if the UE is required to acquire the separate SIB and verify the SI signature before it can start using the information in the Minimum SI there is a risk of increased delays. For example, cell search could take a very long time if the UE is required to verify the SI signature in every cell that it discovers. Another example is when the network re-directs the UE to another cell and the UE needs to quickly setup a connection. To solve this issue, a “late detection” approach may be used where the UE applies the Minimum SI as soon as it has been acquired and where the SI signature verification is done afterwards once the SI signature is acquired. The same approach can be used also for the other parts of SI that is covered by the SI signature.

### Indicating Support of Signed SI

In order to configure the necessary parameters for signed SI e.g. public keys, the network must first know if the UE supports signed SI. In an SI protection negotiation mechanism, the UE could signal its capabilities and where the network could configure the SI signature verification parameters. The SI protection negotiation can either be performed as part of an existing Non-Access Stratum (NAS) procedure, e.g. network registration, or it could be performed using a dedicated NAS procedure, see FIG. 1. The procedure for SI protection negotiation shown in FIG. 1 comprises at least one of the following steps, which steps may be performed in any suitable order than described below:

### Step 10

The UE 103 sends a NAS message to the serving Core Network (CN) node 105. The NAS message may comprise the SI capability of the UE 103.

### Step 11

The serving CN node 105 determines that, for an UE 103 that has proper SU capabilities, it shall send SI protection information to the UE 103.

### Step 12

The serving CN node 105 sends a NAS message to the UE 103. The NAS message comprises SI protection information. The NAS message may comprise at least one of: Tracking Area Identities (TAI), Physical Cell IDS (PCI), Cell IDs, SI numbers, public keys etc.

In network sharing, multiple operators share the same access network, e.g. the same access network. The Third Generation Partnership Project (3GPP) defines two approaches for network sharing, which are illustrated in FIG. 2a and FIG. 2b. FIG. 2a illustrates network sharing using Multi-Operator Core Network (MOCN) and FIG. 2b illustrates network sharing using Gateway Core Network (GWCN). Some difference lies in the handling of the core network:

With the MOCN approach, each network operator has its own core network, e.g. its own Fifth Generation (5G) Core (5GC).

In the GWCN approach, the network operators also share one core network node or core network element, e.g. the Access and Mobility Management Function (AMF) 205 in case of 5G or the Mobility Management Entity (MME) in case of the Fourth Generation (4G) of the core network. Such shared core network node may be responsible for handling connection and mobility management between the UE 103 and the access network.

Even though FIGS. 2a and 2b show the AMF 205 as an example of a core network node 105, the figs. are equally applicable to any other suitable core network node such as for example MME, SGSN etc.

FIG. 2a illustrates that each core network has its respective AMF 205, one or more AMF 205 in each core network, and that AMF's 205 from different core networks, e.g. belonging to different operators, is adapted to be connected to the same network node 101 in a shared radio network, e.g. they share the same network node 101. FIG. 2a shows a core network of operator A comprising two AMFs 205, and a core network of operator B comprising two AMFs 205. One AMF 205 from operator A's core network and one AMF 205 form operator B's core network are connected to the same network node 101 in the shared access network.

FIG. 2b illustrates that two core networks, one for operator A and one for operator B, share the same AMF 205, e.g. the two core networks are adapted to be connected to the same AMF 205. In GWCN, one AMF 205 is adapted to be connected to two or more network nodes 101 in a shared radio network.

In both cases the Public Land Mobile Network Identities (PLMN ID) of the operators sharing the access network are broadcasted in SIB1 to allow the UE 103 to distinguish the networks. Unlike earlier generation systems, 5G also allows each operator to broadcast their own Cell ID and Tracking Area Code (TAC) in SIB1. One way to view this is that the physical cell is divided into several logical cells, one for each operator. The logical cell concept simplifies network planning as each operator can plan their network independently and e.g. assign identifiers without coordinating with other operators.

Regarding signed SI, it has been assumed that the public key used for the signature verification is associated with the operator. Hence, in case of network sharing, multiple signatures may need to be broadcasted as each operator has their own private/public key pair and therefore also their own SI signature. Considering that the size of each SI signature is large, around 512 bits, and there can be up to 12 operators sharing the same cell, this may not be feasible due to the large overhead.

Therefore, there is a need to at least mitigate or solve this issue.

### SUMMARY

An objective of embodiments herein is therefore to obviate at least one of the above disadvantages and to provide improved handling of SI. It provides improved signing of SI in shared and non-shared networks. It enables signed SI in shared and non-shared networks without requiring multiple SI signatures to be broadcasted, the operators use the same private/public key pair for the SI signature generation/verification.

According to a first aspect, the object is achieved by a method performed by a UE for handling SI. The UE obtains one or multiple public keys for SI signature verification. Each of the one or multiple public keys is associated with a validity area of an access network where the public key is valid. The UE obtains a SI together with a SI signature from a network node covering a cell. The SI comprises area identification information. The UE determines, based on the area identification information comprised in the SI, the validity area that the cell belongs to and the corresponding public key. The UE verifies the SI signature using the determined corresponding public key.

According to a second aspect, the object is achieved by a method performed by a network node for handling SI. The network node generates a SI signature for at least one cell in the access network using a private key corresponding to a validity area that the cell belongs to. The network node provides, to the UE, the SI in the cell which the network node covers, together with the SI signature. The SI comprises area identification information.

According to a third aspect, the object is achieved by a UE adapted for handling SI. The UE is adapted to obtain one or multiple public keys for SI signature verification. Each of the one or multiple public keys is associated with a validity area of an access network where the public key is valid. The UE is adapted to obtain a SI together with a SI signature from a network node covering a cell. The SI comprises area identification information. The UE is adapted to determine, based on the area identification information comprised in the SI, the validity area that the cell belongs to and the corresponding public key. The UE is adapted to verify the SI signature using the determined corresponding public key.

According to a fourth aspect, the object is achieved by a network node adapted for handling SI. The network node is adapted to generate a SI signature for at least one cell in the access network using a private key corresponding to a validity area that the cell belongs to. The network node is adapted to provide, to the UE, the SI in the cell which the network node covers, together with the SI signature. The SI comprises area identification information.

To enable signed SI in shared networks without requiring multiple SI signatures to be broadcasted, the operators use the same private/public key pair for the SI signature generation/verification. In this way only a single SI signature needs to be broadcasted in the shared network cell. The private/public key pair is further associated with one or more tracking areas, or any other identifier representing a certain area of the network, e.g. one or more Cell IDs, to allow an operator to use multiple private/public keys in their network. This increases security as a compromise of a private key only affects the part of the network associated with the key. It also improves flexibility for the operator since the private/public key can be selected independently of other operators in the parts of the network which is not shared with other operators. Operator A uses the same private/public key pair as operator B in the shared access network but uses a different private/public key pair in the non-shared access network. The public key and the associated network area where the public key is valid can either be pre-configured in the UE, e.g. in the Subscriber Identity Module (SIM) card, embedded SIM (eSIM) or other identity module, or signaled to the UE during e.g. network registration.

Embodiments herein afford many advantages, of which a non-exhaustive list of examples follows:

The embodiments herein allow SI to be signed also in shared network scenarios where multiple operators share the same access network. The embodiments herein are also applicable to non-shared networks in the same way as in shared networks. By using the same private/public key pair for all the operators only a single SI signature needs to be broadcasted in an access network cell which reduces overhead. Furthermore, each operator is only required to use the private/public key in the areas of the parts of the access network that are shared; in areas where the access network is not shared or in areas where the access network is shared with another group of operators a different private/public key can be used. This improves flexibility for the operator and is accomplished by associating the private/public key pair with a network area identifier, e.g. list of tracking areas or cells.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1 is a signaling diagram illustrating an example of SI protection negotiation.

FIG. 2a is a schematic block diagram illustrating an example of network sharing based on MOCN.

FIG. 2b is a schematic block diagram illustrating an example of network sharing based on GWCN.

FIG. 3 is a schematic block diagram illustrating an example of a communications network.

FIG. 4 is a schematic block diagram illustrating an example of different private/public key pairs in different areas of the network.

FIG. 5 is a flow chart illustrating an example of a method performed by the UE.

FIG. 6 is a flow chart illustrating an example of a method performed by a network node.

FIG. 7a-7b are schematic drawings illustrating an example of a UE.

FIG. 8a-8b are schematic drawings illustrating an example of a node.

FIG. 9 is a schematic block diagram illustrating a telecommunication network connected via an intermediate network to a host computer.

FIG. 10 is a schematic block diagram of a host computer communicating via a base station with a UE over a partially wireless connection.

FIG. 11 is a flowchart depicting embodiments of a method in a communications system comprising a host computer, a base station and a UE.

FIG. 12 is a comprising depicting embodiments of a method in a communications system comprising a host computer, a base station and a UE.

FIG. 13 is a flowchart depicting embodiments of a method in a communications system comprising a host computer, a base station and a UE.

FIG. 14 is a flowchart depicting embodiments of a method in a communications system comprising a host computer, a base station and a UE.

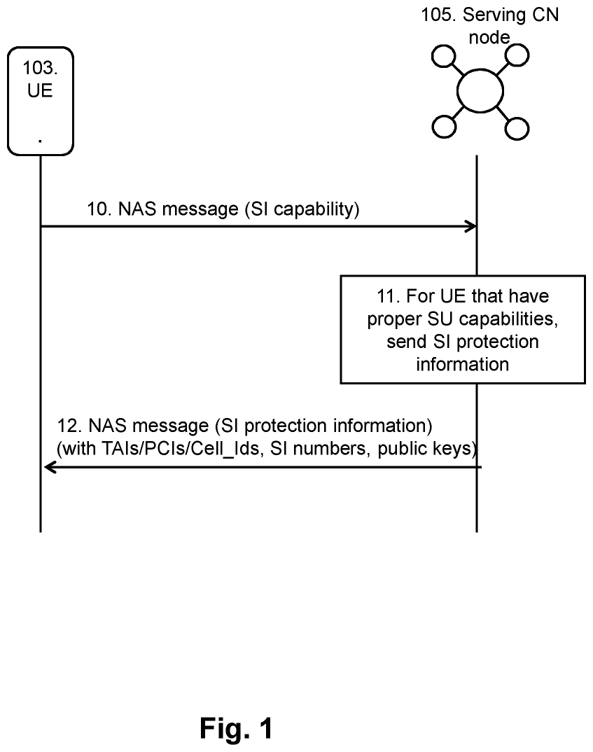

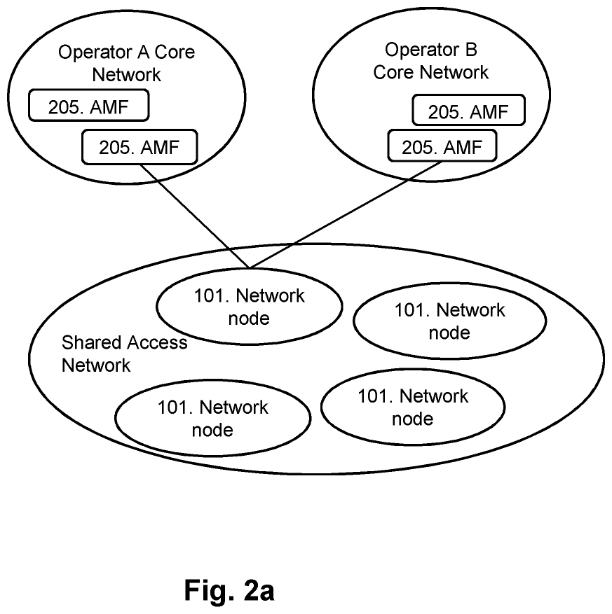

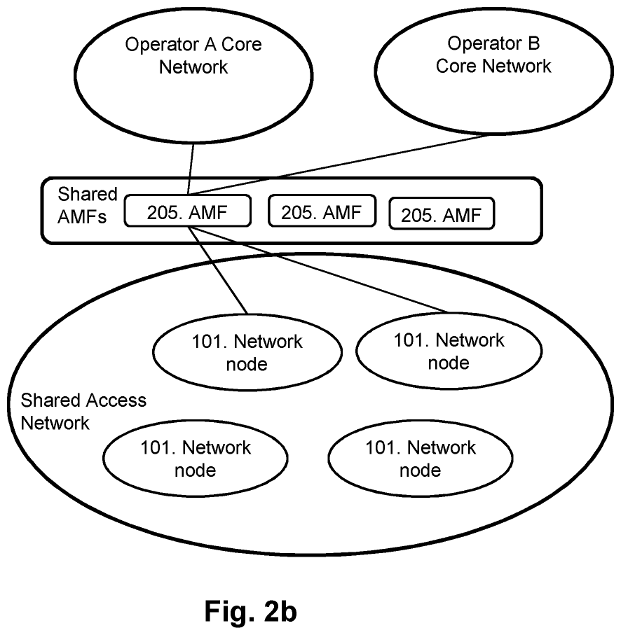

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relate to configuring a UE 103 with multiple public keys for SI signature verification where each public key is associated with a particular area of the access network.

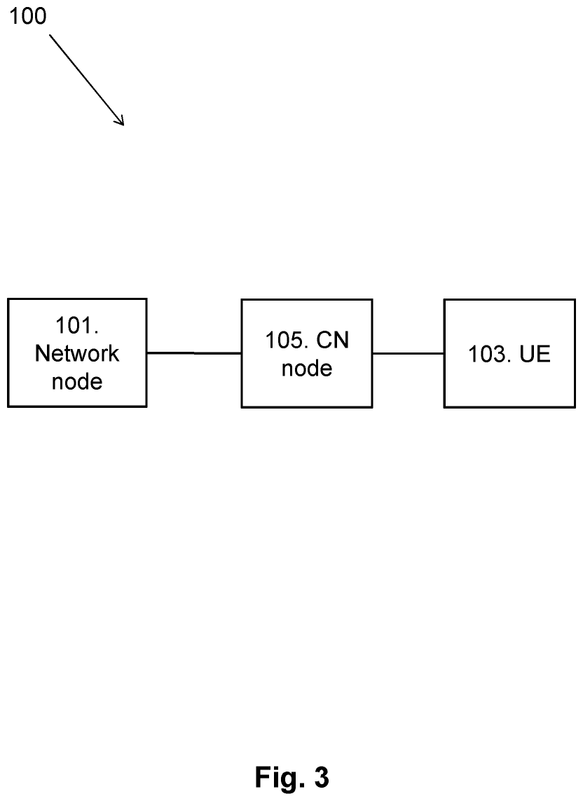

FIG. 3 depicts a non-limiting example of a communications network 100, which may be a wireless communications system, sometimes also referred to as a wireless communications network, cellular radio system, or cellular network, in which embodiments herein may be implemented. The communications network 100 may be a 5G system, 5G network, New Radio-Unlicensed (NR-U) or Next Gen system or network. The communications network 100 may alternatively be a younger system than a 5G system. The communications network 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, Narrowband Internet of Things (NB-IoT). Thus, although terminology from 5G/NR and LTE may be used in this disclosure to exemplify embodiments herein, this should not be seen as limiting the scope of the embodiments herein to only the aforementioned systems.

The communications network 100 comprises one or a plurality of network nodes, whereof the network node 101 is depicted in the non-limiting example of FIG. 3. The network node 101 may be a radio network node, such as a radio base station, a radio access network node, an access network node or any other network node with similar features capable of serving a UE 103, such as a wireless device or a machine type communication device, in the communications network 100. The network node 101 may be an evolved Node B (eNB), gNB, Master eNB (MeNB), Radio Network Controller (RNC), Node B (NB), etc.

The communications network 100 may cover a geographical area which may be divided into cell areas. Each cell area may be served by a network node 101, although, one network node 101 may serve one or several cells. Note that any n number of cells may be comprised in the communications network 100, where n is any positive integer. A cell is a geographical area where radio coverage is provided by the network node 101 at a network node site. Each cell is identified by an identity within the local network node area, which is broadcast in the cell. In FIG. 3, network node 101 may serve a cell. The network node 101 may be of different classes, such as, e.g. macro Base Station (BS), home BS or pico BS, based on transmission power and thereby also cell size. The network node 101 may be a distributed node, such as a virtual node in the cloud, and it may perform its functions entirely on the cloud, or partially, in collaboration with another network node.

The network node 101 may be directly or indirectly connected to one or more core networks (CN), e.g. represented by a CN node 105 in FIG. 3. Note that only one CN node 105 is shown in FIG. 3 for the sake of simplicity, but any other suitable number of CN nodes 105 may be located in the communications network 100. The CN node 105 may be any suitable CN node such as e.g. a Serving Gateway (SGW), Packet Data Network Gateway (PGW), Gateway General Packet Radio Services (GPRS) Support Node (GGSN), Serving GPRS Support Node (SGSN), Mobility Management Entity (MME), Access and Mobility Management Function (AMF), User Plane Function (UPF), Session Management Function (SMF), Home Location Register (HLR), Home Subscriber Server (HSS), (Policy Charging Function (PCF), Application Function (AF), Unified Data Management (UDM), Authentication Server Function (AUSF), Network Repository Function (NRF), Network Exposure Function (NEF), Network Slice Selection Function (NSSF), Charging Function (CHF) etc. The CN node 105 may be referred to as a serving CN node, i.e. CN node 105 which is currently serving the UE 103. The CN node 105 may also referred to as a first CN node, or a home CN node.

One or a plurality of UEs 103 is located in the communications network 100. Only one UE 103 is exemplified in FIG. 3 for the sake of simplicity. A UE 103 may also be referred to simply as a device. The UE 103, e.g. a LTE UE or a 5G/NR UE, may be a wireless communication device which may also be known as e.g. a wireless device, a mobile terminal, wireless terminal and/or mobile station, a mobile telephone, cellular telephone, or laptop with wireless capability, just to mention some further examples. The UE 103 may be a device by which a subscriber may access services offered by an operator's network and services outside the operator's network to which the operator's access network and core network provide access, e.g. access to the Internet. The UE 103 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 103 may be portable, pocket storable, hand held, computer comprised, or vehicle mounted devices, enabled to communicate voice and/or data, via the access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications network 100.

The UE 103 is enabled to communicate wirelessly within the communications network 100. The communication may be performed e.g. between two UEs 103, between a UE 103 and a regular telephone, between the UE 103 and a network node, between network nodes, and/or between the UEs 103 and a server via the access network and possibly one or more core networks and possibly the internet.

The network node 101 may be configured to communicate in the communications network 100 with the UE 103 over a communication link, e.g. a radio link.

It should be noted that the communication links in the communications network 100 may be of any suitable kind comprising either a wired or wireless link. The link may use any suitable protocol depending on type and level of layer, e.g. as indicated by the Open Systems Interconnection (OSI) model, as understood by the person skilled in the art.

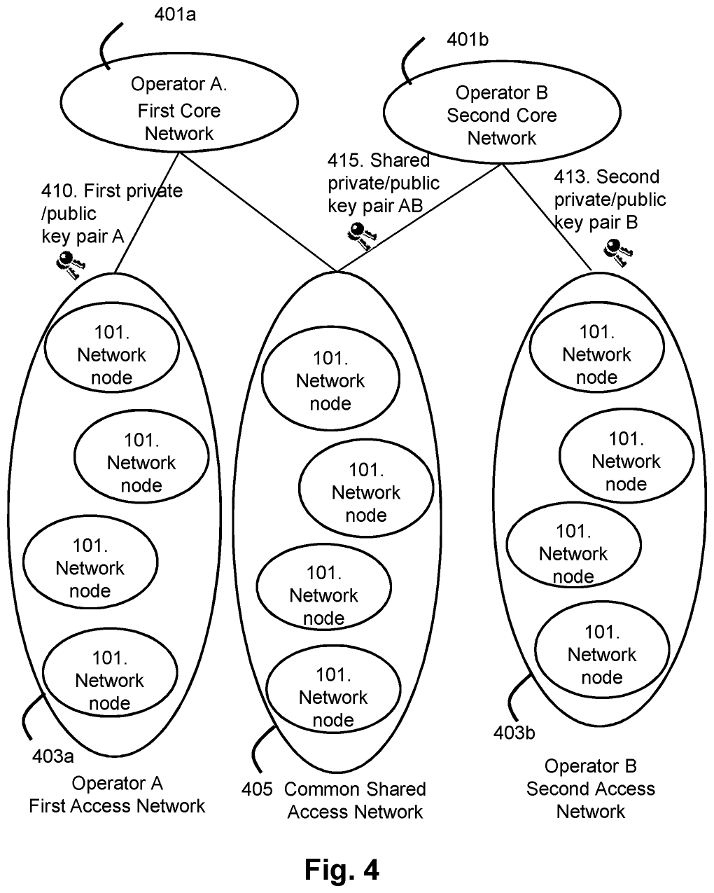

To enable signed SI in shared networks without requiring multiple SI signatures to be broadcasted, the operators use the same private/public key pair for the SI signature generation/verification. In this way only a single SI signature needs to be broadcasted in the shared network cell. The private/public key pair is further associated with one or more tracking areas, or any other identifier representing a certain area of the network, e.g. one or more Cell IDs, to allow an operator to use multiple private/public keys in their network. This increases security as a compromise of a private key only affects the part of the network associated with the key. It also improves flexibility for the operator since the private/public key can be selected independently of other operators in the parts of the network which is not shared with other operators. This is illustrated in FIG. 4 where operator A uses the same private/public key pair as operator B in the common shared access network 405 but uses a different private/public key pair in the non-shared access network. The public key and the associated network area where the public key is valid can either be pre-configured in the UE 103, e.g. in the Subscriber Identity Module (SIM) card, embedded SIM (eSMI), or other UE identity module, or signaled to the UE 103 during e.g. network registration.

FIG. 4 shows different private/public key pairs in different areas of the network with an example with two operators, i.e. operator A and operator B. Operator A may be referred to as a first operator and operator B may be referred to as a second operator. Note that two operators are only shown as an example and that any n number of operators may be applicable, where n is a positive integer larger than 1.

Operator A is associated with a first core network 401a and a first access network 403a. Operator B is associated with a second core network 401b and a second access network 403b. The common shared access network 405 is shared between operator A and operator B, i.e. it is common to operators A and B. In other words, the first core network 401a and the second core network 401b is adapted to be both connected to the shared access network 405. The first core network 401a is adapted to be connected to the first access network 403a and the shared access network 405. The second core network 401b is adapted to be connected to the second access network 403b and the shared access network 405.

The first core network 401a comprises one or multiple first core network nodes 105 (not shown in FIG. 4). The second core network 401b comprises one or multiple second core network nodes 105 (not shown in FIG. 4). The first access network 403a comprises one or multiple first network nodes 101. Only four first network nodes 101 are illustrated in FIG. 4 as an example, but any n number of first network nodes 101 is applicable, where n is a positive integer. The second access network 403b comprises one or multiple second network nodes 101. Only four second network nodes 101 are illustrated in FIG. 4 as an example, but any n number of second network nodes 101 is applicable, where n is a positive integer. The shared access network 405 comprises one or multiple shared network nodes 101. Only four shared network nodes 101 are illustrated in FIG. 4 as an example, but any n number of shared network nodes 101 is applicable, where n is a positive integer.

A first private/public key pair A 410 is associated with the first core network 401a and the first access network 403a. A second private/public key pair B 413 is associated with the second core network 401b and the second access network 403b. A shared private/public key pair AB 415 is associated with the first core network 401a, the second core network 401b and the shared access network 405.

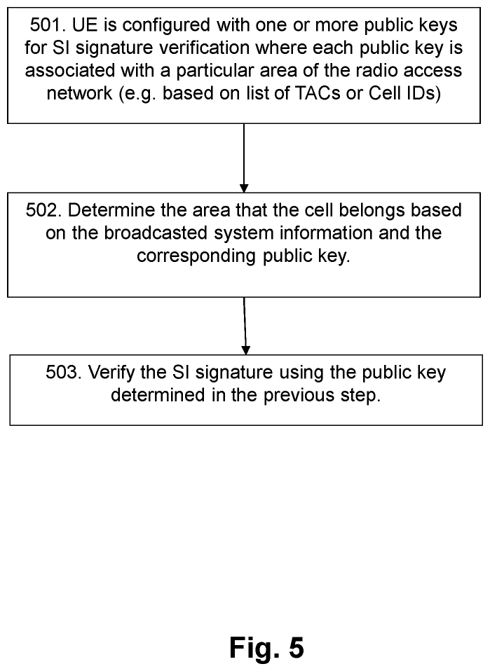

FIG. 5 is a flow chart illustrating an example of a method performed by the UE 103. The method comprises at least one of the following steps to be performed by the UE 103, which steps may be performed in any suitable order than described below:

### Step 501

The UE 103 is configured by the network/operator, e.g. network node 101, with one or more public keys for SI signature verification where each public key is associated with an area of the access network where the public key is valid. The area may be referred to as a validity area. The validity area can e.g. be represented by one or more TACs, Cell IDs, RAN Area Codes (RACs), or PCIs, or any combination thereof. The public key and validity area can either be pre-configured in the UE 103, e.g. in the SIM card, eSIM, identity module etc., or it may be signalled to the UE 103 during e.g. the NAS network registration procedure. It is also possible for the network/operator, e.g. the network node 101, to update the public key and validity area, for example when the UE 103 enters a new registration area and executes the mobility triggered network registration procedure. Furthermore, UE mobility patterns could be built and used for provisioning the UE 103 with the appropriate public keys for minimizing the frequency of UE configuration update messages. In other words, the network node 101 could provision the public keys for the areas that the UE 103 can move into based on mobility patterns. Moreover, the public keys could be provisioned to the UE 103 upon handovers. It is also possible to revoke public keys using e.g. the same NAS procedures as are used for configuring new public keys.

Step 501 may be summarized as follows: The UE 103 obtains, e.g. preconfigured or signalled to UE 103 during e.g. network registration, one or multiple public keys for SI signature verification. Each of the one or multiple public keys is associated with a validity area of an access network where the public key is valid. The UE 103 obtains, e.g. via broadcast or unicast, a SI together with a SI signature from a network node 101 covering a cell. The SI comprises area identification information

The validity area may be associated with one or more of: TAC, Cell IDs, RACs, PCIs, or any combination thereof.

The obtained one or multiple public keys may be updated public keys which is updated compared to previous obtained one or multiple public keys, e.g. when the UE 103 enters a new registration area and executes a network registration procedure, e.g. mobility triggered.

When multiple public keys are obtained, then the multiple public keys may be associated with the UE's mobility pattern, e.g. the multiple public keys are associated with areas that the UE 103 can move into.

The one or multiple public keys may be obtained by reception from a network node 101, 30 e.g. during NAS signaling, or obtained by being preconfigured in the UE 103, e.g. by the network node 101 and e.g. in a SIM card of the UE 103.

The one or multiple public keys may be obtained during handover of the UE 103 from one network node 101 to another network node 101.

### Step 502

To verify the SI signature in a cell, the UE 103 determines the area that the cell belongs to and the corresponding public key. If the area is represented by a list of TAC, this can be done by matching the TAC signalled for the operator in SIB1 against the list of TACs associated with each public key until a first match is found. If no match is found, the UE 103 can apply a late verification approach, i.e. the UE 103 camps on the cell even though the SI has not (yet) been verified and performs network registration where it will receive the public key to verify the SI signature.

Step 502 may be summarized as follows: The UE 103 determines, based on the area identification information comprised in the SI, the validity area that the cell belongs to and the corresponding public key.

The UE 103 may compare a TAC, signaled for an operator in SIB1 with TACs in a list of TACs associated with each public key in the area identification information comprised in the SI. The UE 103 may verify the SI signature when the TAC signaled for the operator in SIB1 matches one TAC in the list of TACs associated with each public key. When the TAC signaled for the operator in SIB1 does match any TACs in the list of TACs associated with each public key, the UE 103 may apply a late verification approach, e.g. the UE 103 camps on the cell even though the SI has not been verified and performs network registration where it will receive the public key to verify the SI signature.

### Step 503

The UE 103 verifies the SI signature using the public key determined in the previous step 502.

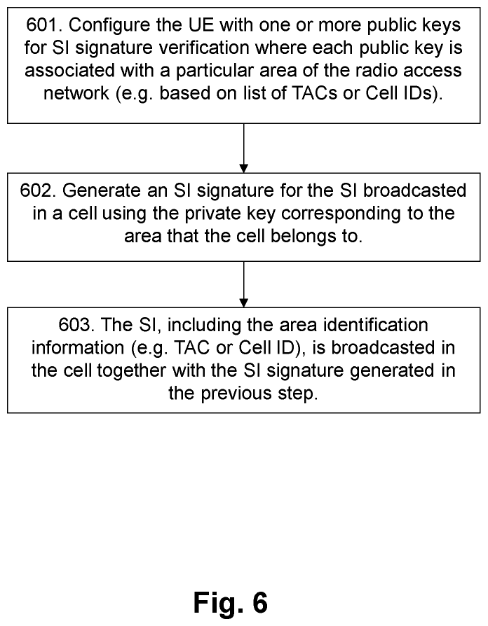

The UE 103 may obtain information indicating that at least one of the one or multiple public keys should be revoked, e.g. in the same NAS procedure used for obtaining the one or multiple public keys. The UE 103 may revoke the one or multiple public keys. FIG. 6 is a flow chart illustrating an example of a method performed by the network node 101. The method comprises at least one of the following steps to be performed by the network node 101, which steps may be performed in any suitable order than described below:

### Step 601

The network/operator, e.g. the network node 101, may configure the UE 103 with one or more public keys for SI signature verification where each public key is associated with an area of the access network where the public key is valid. The area may be referred to as a validity area. For more details, see the corresponding step 501 on the UE side in FIG. 5.

The network node 101 may provide the UE 103 with one or multiple public keys for SI signature verification. Each of the one or multiple public keys may be associated with a validity area of an access network where the public key is valid.

The provided one or multiple public keys may be updated public keys which is updated compared to previous provided one or multiple public keys, e.g. when the UE 103 enters a new registration area and executes a network registration procedure, e.g. mobility triggered.

When multiple public keys are provided, then the multiple public keys may be associated with the UE's mobility pattern, e.g. the multiple public keys are associated with areas that the UE 103 can move into.

The one or multiple public keys may be provided by transmission from the network node 101, e.g. during NAS signaling, or obtained by being preconfigured in the UE 103 by the network node 101, and e.g. in a SIM card in the UE 103.

The one or multiple public keys may be provided during handover of the UE 103 from one network node 101 to another network node 101.

### Step 602

For each cell in the access network using signed SI, the network/operator, e.g. the network node 101, generates a signature using the private key corresponding to the area that the cell belongs to.

Step 602 may be summarized as follows: The network node 101 generates a SI signature for at least one cell in the access network using a private key corresponding to a validity area that the cell belongs to.

### Step 603

The SI, which includes the area identification information, e.g. TAC or Cell ID, is broadcasted by the network node 101 in the cell together with the SI signature generated in the previous step.

Step 603 may be summarized as follows: The network node 101 provides, e.g. by broadcasting or unicasting, to the UE 103, the SI in the cell which the network node 101 covers, together with the SI signature. The SI comprises area identification information, e.g. TAC and/or Cell ID.

The network node 101 may provide, to the UE 103, information indicating that at least one of the one or multiple public keys should be revoked, e.g. in the same NAS procedure used for obtaining the one or multiple public keys.

The embodiments as described herein may be applied in both MOCN and GWCN type of network sharing. One difference is that in the MOCN case only the access network is shared between the operators while in the GWCN also the AMF is shared.

Although the embodiments herein are described in the context of network sharing, the embodiments may also be applied in non-shared network, i.e. where the access network is only used by a single operator/PLMN. Even though there is only a single operator there may still be e.g. security benefits of using different private/public keys in different parts of the access network.

The embodiments may also be applied in cases where the SI signature is unicasted to the UE 103 rather than broadcasted. For example, the SI signature can be sent by the network node 101 to the UE 103 using dedicated RRC or NAS signaling.

In some embodiments, if no associated validity area is provided for a public key, the UE 103 assumes the public key is valid within the whole network/PLMN.

Note that although the methods herein may, in some places, be described in the context of NR, the same methods may be applied to any access technologies that make use of SI like LTE or Narrowband-Internet of Things (NB-IoT).

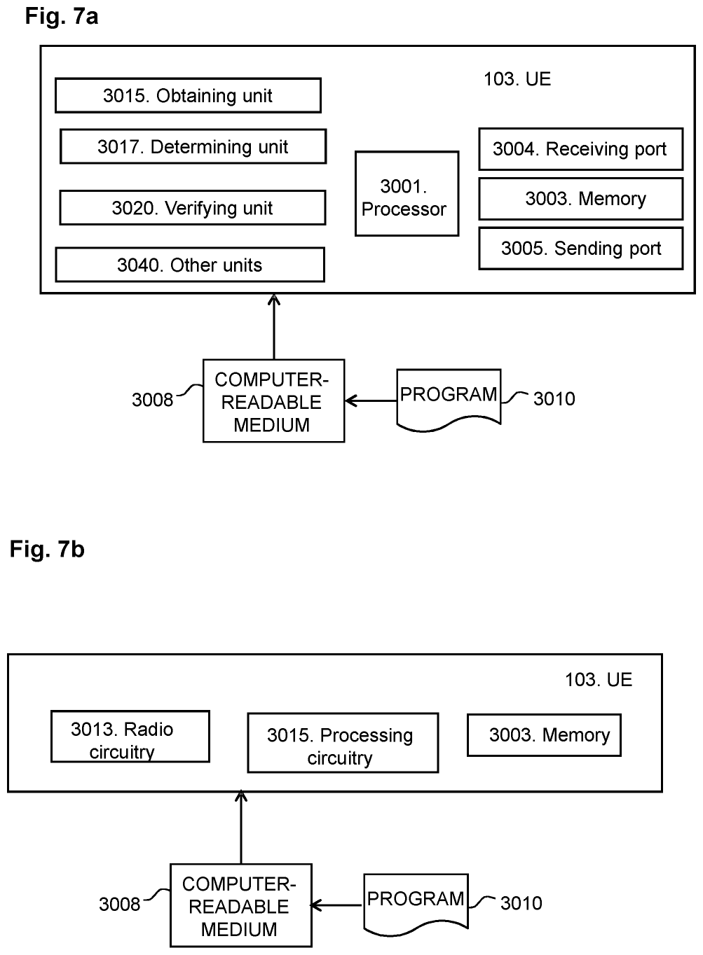

FIG. 7a and FIG. 7b depict two different examples in panels a) and b), respectively, of the arrangement that the UE 103 may comprise. In some embodiments, the UE 103 may comprise the following arrangement depicted in FIG. 7a.

The embodiments herein in the UE 103 may be implemented through one or more processors, such as a processor 3001 in the UE 103 depicted in FIG. 7a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the UE 103. One such carrier may be in the form of a Compact Disc Read-Only Memory (CD ROM) disc. It is however feasible with other data carriers such as a memory stick. The computer program code may furthermore be provided as pure program code on a server and downloaded to the UE 103.

The UE 103 may further comprise a memory 3003 comprising one or more memory units. The memory 3003 is arranged to be used to store obtained information, store data, configurations, schedulings, and applications etc. to perform the methods herein when being executed in the UE 103.

In some embodiments, the UE 103 may receive information from, e.g. the network node 101, through a receiving port 3004. In some embodiments, the receiving port 3004 may be, for example, connected to one or more antennas in UE 103. In other embodiments, the UE 103 may receive information from another structure in the communications system through the receiving port 3004. Since the receiving port 3004 may be in communication with the processor 3001, the receiving port 3004 may then send the received information to the processor 3001. The receiving port 3004 may also be configured to receive other information.

The processor 3001 in the UE 103 may be further configured to transmit or send information to e.g. network node 101 or another structure in the communications network 100, through a sending port 3005, which may be in communication with the processor 3001, and the memory 3003.

The UE 103 may comprise an obtaining unit 3015, a determining unit 3017, a verifying unit 3020 and other units 3040.

The UE 103 is adapted to, e.g. by means of the obtaining unit 3015, obtain one or multiple public keys for SI signature verification. Each of the one or multiple public keys is associated with a validity area of an access network where the public key is valid. The validity may be associated with one or more of: TACs, Cell IDs, RACs, PCIs or any combination thereof. The obtained one or multiple public keys may be updated public keys which is updated compared to previous obtained one or multiple public keys, e.g. when the UE 103 enters a new registration area and executes a network registration procedure, e.g. mobility triggered. When multiple public keys are obtained, then the multiple public keys may be associated with the UE's mobility pattern, e.g. the multiple public keys may be associated with areas that the UE 103 can move into. The one or multiple public keys may be obtained by reception from a network node 101, e.g. during NAS signaling, or obtained by being preconfigured in the UE 103, e.g. by the network node 101 and e.g. in a SIM card of the UE 103. The one or multiple public keys may be obtained during handover of the UE 103 from one network node 101 to another network node 101.

The UE 103 is adapted to, e.g. by means of the obtaining unit 3015, obtain a SI together with a SI signature from a network node 101 covering a cell, wherein the SI comprises area identification information.

The UE 103 is adapted to, e.g. by means of the determining unit 3017, determine, based on the area identification information comprised in the SI, the validity area that the cell belongs to and the corresponding public key.

The UE 103 is adapted to, e.g. by means of the verifying unit 3020, verify the SI signature using the determined corresponding public key.

The UE 103 may be adapted to, e.g. by means of the obtaining unit 3015, obtain information indicating that at least one of the one or multiple public keys should be revoked.

The UE 103 may be adapted to, e.g. by means of the processor 3001, revoke the one or multiple public keys.

The UE 103 may be adapted to, e.g. by means of the processor 3001, compare a TAC signaled for an operator in SIB1 with TACs in a list of TACs associated with each public key in the area identification information comprised in the SI.

The UE 103 may be adapted to, e.g. by means of the verifying unit 3020, verify the SI signature when the TAC signaled for the operator in SIB1 matches one TAC in the list of TACs associated with each public key.

The UE 103 may be adapted to, e.g. by means of the processor 3001, when the TAC signaled for the operator in SIB1 does match any TACs in the list of TACs associated with each public key, apply a late verification approach, e.g. the UE 103 may camp on the cell even though the SI has not been verified and performs network registration where it will receive the public key to verify the SI signature.

Those skilled in the art will also appreciate that the obtaining unit 3015, the determining unit 3017, the verifying unit 3020 and the other units 3040 described above may refer to a combination of analog and digital circuits, and/or one or more processors configured with software and/or firmware, e.g., stored in memory, that, when executed by the one or more processors such as the processor 3001, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, in some embodiments, the different units 3015-3040 described above may be implemented as one or more applications running on one or more processors such as the processor 3001.

Thus, the methods according to the embodiments described herein for the UE 103 may be respectively implemented by means of a computer program 3010 product, comprising instructions, i.e., software code portions, which, when executed on at least one processor 3001, cause the at least one processor 3001 to carry out the actions described herein, as performed by the UE 103. The computer program 3010 product may be stored on a computer-readable storage medium 3008. The computer-readable storage medium 3008, having stored thereon the computer program 3010, may comprise instructions which, when executed on at least one processor 3001, cause the at least one processor 3001 to carry out the actions described herein, as performed by the UE 103. In some embodiments, the computer-readable storage medium 3008 may be a non-transitory computer-readable storage medium, such as a CD ROM disc, or a memory stick. In other embodiments, the computer program 3010 product may be stored on a carrier comprising the computer program 3010 just described, wherein the carrier is one of an electronic signal, optical signal, radio signal, or the computer-readable storage medium 3008, as described above.

The UE 103 may comprise a communication interface configured to facilitate communications between the UE 103 and other nodes or devices, e.g., the network node 101 or another structure. The interface may, for example, comprise a transceiver configured to transmit and receive radio signals over an air interface in accordance with a suitable standard.

In other embodiments, the UE 103 may comprise the following arrangement depicted in FIG. 7b. The UE 103 may comprise a processing circuitry 3015, e.g., one or more processors such as the processor 3001, in the UE 103 and the memory 3003. The UE 103 may also comprise a radio circuitry 3013, which may comprise e.g., the receiving port 3004 and the sending port 3005. The processing circuitry 3011 may be configured to, or operable to, perform the method actions according to FIG. 5, in a similar manner as that described in relation to FIG. 7a. The radio circuitry 3013 may be configured to set up and maintain at least a wireless connection with the UE 103. Circuitry may be understood herein as a hardware component.

Hence, embodiments herein also relate to the UE 103 operative to operate in the communications network 100. The UE 103 may comprise the processing circuitry 3015 and the memory 3003, said memory 3003 comprising instructions executable by the processing circuitry 3015, whereby the UE 103 is further operative to perform the actions described herein in relation to the UE 103, e.g., in FIG. 5.

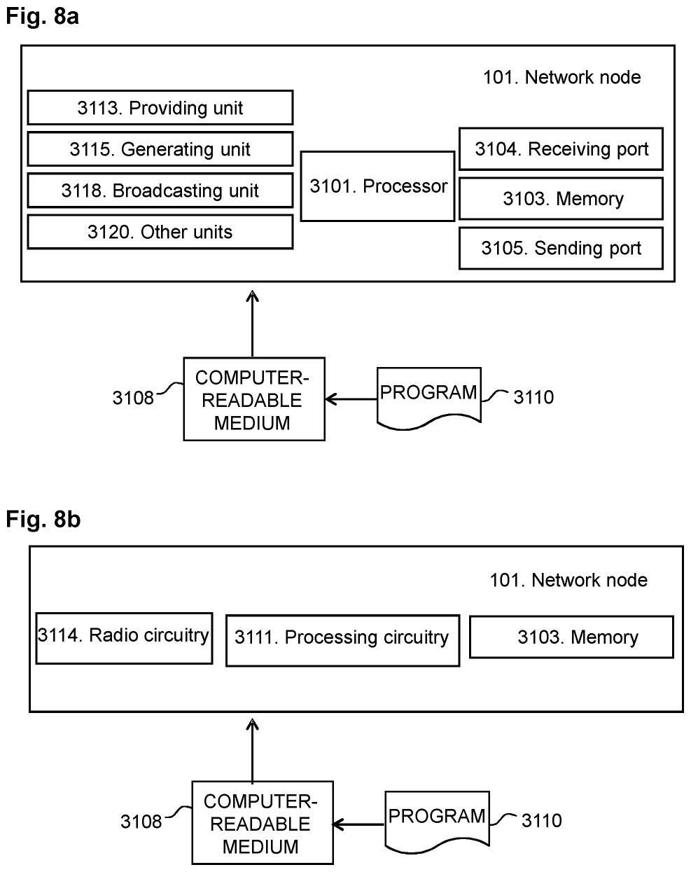

FIG. 8a and FIG. 8b depict two different examples in panels a) and b), respectively, of the arrangement that the network node 101 may comprise. In some embodiments, the network node 101 may comprise the following arrangement depicted in FIG. 88.

The embodiments herein in the network node 101 may be implemented through one or more processors, such as a processor 3101 in the network node 101 depicted in FIG. 8a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 101. One such carrier may be in the form of a CD ROM disc. It is however feasible with other data carriers such as a memory stick. The computer program code may furthermore be provided as pure program code on a server and downloaded to the network node 101.

The network node 101 may further comprise a memory 3103 comprising one or more memory units. The memory 3103 is arranged to be used to store obtained information, store data, configurations, schedulings, and applications etc. to perform the methods herein when being executed in the network node 101.

In some embodiments, the network node 101 may receive information from, e.g. the UE 103 and/or another network node, through a receiving port 3104. In some embodiments, the receiving port 3104 may be, for example, connected to one or more antennas in network node 101. In other embodiments, the network node 101 may receive information from another structure in the communications network 100 the receiving port 3104. Since the receiving port 3104 may be in communication with the processor 3101, the receiving port 3104 may then send the received information to the processor 3101. The receiving port 3104 may also be configured to receive other information.

The processor 3101 in the network node 101 may be further configured to transmit or send information to e.g. the UE 103, or another structure in the communications network 100, through a sending port 3105, which may be in communication with the processor 3101 and the memory 3103.

The network node 101 may comprise a providing unit 3113, a generating unit 3115, a broadcasting unit 3118 and other units 3020 etc.

The network node 101 is adapted to, e.g. by means of the generating unit 3115, generate a SI signature for at least one cell in the access network using a private key corresponding to a validity area that the cell belongs to.

The network node 101 is adapted to, e.g. by means of the providing unit 3113, provide, to the UE 103, the SI in the cell which the network node 101 covers, together with the SI signature. The SI may comprise area identification information, e.g. TACs and/or Cell ID.

The network node 101 may be adapted to, e.g. by means of the providing unit 3113, provide the UE 103 with one or multiple public keys for SI signature verification. Each of the one or multiple public keys may be associated with a validity area of an access network where the public key is valid. The provided one or multiple public keys may be updated public keys which may be updated compared to previous provided one or multiple public keys, e.g. when the UE 103 enters a new registration area and executes a network registration procedure, e.g. mobility triggered. When multiple public keys are provided, then the multiple public keys may be associated with the UE's mobility pattern, e.g. the multiple public keys may be associated with areas that the UE 103 can move into. The one or multiple public keys may be provided by transmission from the network node 101, e.g. during NAS signaling, or obtained by being preconfigured in the UE 103 by the network node 101 and e.g. in a SIM card of the UE 103. The one or multiple public keys may be provided during handover of the UE 103 from one network node 101 to another network node 101.

The one or multiple public key may be associated with one or more tracking areas, or any other identifier representing a certain area of the network, e.g. one or more Cell IDs, to allow an operator to use multiple private/public keys in their network.

The network node 101 may be comprised in a communications network 100, the communications network 100 may be a shared network or non-shared network, and the shared communications network may apply MOCN, or a GWCN type of network sharing.

The communications network 100 may be a 2G network, a 3G network, a 4G network, a 5G network, a 6G network or any other legacy, current of future network.

The network node 101 may be e.g. a base station, node B, eNB, gNB, RNC, MeNB etc, or a CN node 105 as exemplified above.

Those skilled in the art will also appreciate that the providing unit 3113, the generating unit 3115, the broadcasting unit 3118, the other units 3020 etc. described above may refer to a combination of analog and digital circuits, and/or one or more processors configured with software and/or firmware, e.g., stored in memory, that, when executed by the one or more processors such as the processor 3101, perform as described above. One or more of these processors, as well as the other digital hardware, may be comprised in a single ASIC, or several processors and various digital hardware may be distributed among several separate components, whether individually packaged or assembled into a SoC.

Also, in some embodiments, the different units 3113-3020 described above may be implemented as one or more applications running on one or more processors such as the processor 3101.

Thus, the methods according to the embodiments described herein for the network node 101 may be respectively implemented by means of a computer program 3110 product, comprising instructions, i.e., software code portions, which, when executed on at least one processor 3101, cause the at least one processor 3101 to carry out the actions described herein, as performed by the network node 101. The computer program 3110 product may be stored on a computer-readable storage medium 3108. The computer-readable storage medium 3108, having stored thereon the computer program 3110, may comprise instructions which, when executed on at least one processor 3101, cause the at least one processor 3101 to carry out the actions described herein, as performed by the network node 101. In some embodiments, the computer-readable storage medium 3110 may be a non-transitory computer-readable storage medium, such as a CD ROM disc, or a memory stick. In other embodiments, the computer program 3110 product may be stored on a carrier comprising the computer program 3110 just described, wherein the carrier is one of an electronic signal, optical signal, radio signal, or the computer-readable storage medium 3108, as described above.

The network node 101 may comprise a communication interface configured to facilitate communications between the network node 101 and other nodes or devices, e.g., the UE 103, or another structure. The interface may, for example, comprise a transceiver configured to transmit and receive radio signals over an air interface in accordance with a suitable standard.

In other embodiments, the network node 101 may comprise the following arrangement depicted in FIG. 8b. The network node 101 may comprise a processing circuitry 3111, e.g., one or more processors such as the processor 3101, in the network node 101 and the memory 3103. The network node 101 may also comprise a radio circuitry 3114, which may comprise e.g., the receiving port 3104 and the second sending port 3105. The processing circuitry 3111 may be configured to, or operable to, perform the method actions according to FIG. 6 in a similar manner as that described in relation to FIG. 8a. The radio circuitry 3114 may be configured to set up and maintain at least a wireless connection with the network node 101. Circuitry may be understood herein as a hardware component.

Hence, embodiments herein also relate to the network node 101 to operate in the communications network 100. The network node 101 may comprise the processing circuitry 3111 and the memory 3103. The memory 3103 comprises instructions executable by said processing circuitry 3111, whereby the network node 101 is further operative to perform the actions described herein in relation to the network node 101, e.g., FIG. 5.

### Further Extensions and Variations

Telecommunication network connected via an intermediate network to a host computer in accordance with some embodiments.

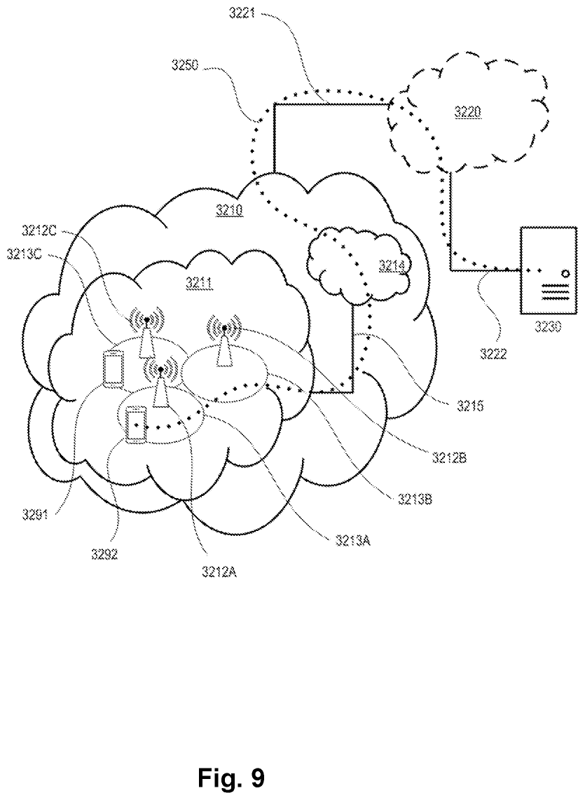

With reference to FIG. 9, in accordance with an embodiment, a communications network 100 comprises a telecommunication network 3210 such as the communications network 100, for example, a 3GPP-type cellular network, which comprises access network 3211, such as an access network, and core network 3214. Access network 3211 comprises a plurality of network nodes 101. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of UEs, such as the UE 103 may be comprised in the communications network 100. In FIG. 9, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212. Any of the UEs 3291, 3292 may be considered examples of the UE 103.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communications network 100 of FIG. 9 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, the base station 3212 need not be aware of the future routing of an outgoing uplink communication originating from the UE 3291 towards the host computer 3230.

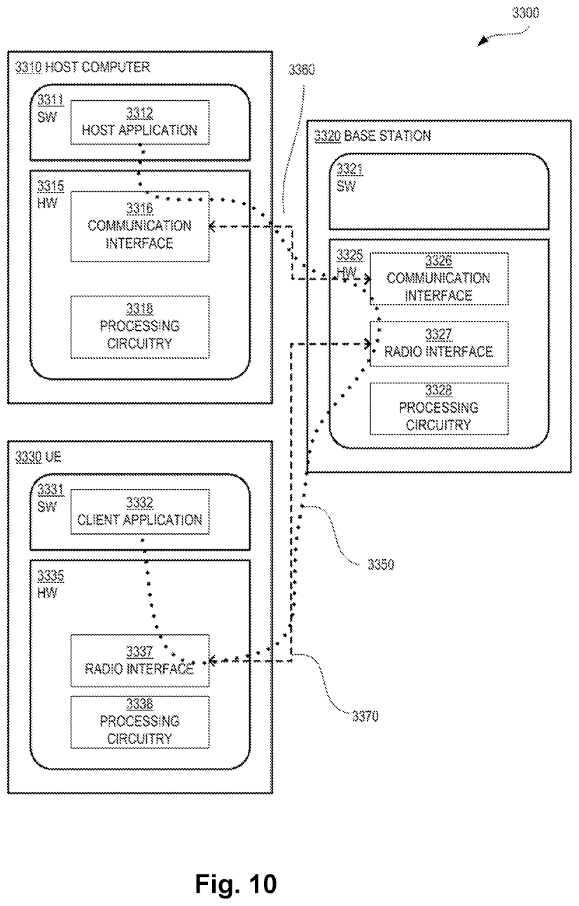

In relation to FIGS. 10-14 which are described next, it may be understood that the base station may be considered an example of the network node 101.

FIG. 10 illustrates an example of host computer communicating via a network node 101 with a UE 103 over a partially wireless connection in accordance with some embodiments

The UE 103 and the network node 101, e.g., a base station and host computer discussed in the preceding paragraphs will now be described with reference to FIG. 10. In communication system 3300, such as the communications network 100, host computer 3310 comprises hardware 3315 comprising communication interface 3316 configured to set up and maintain a wired or wireless connection with an interface of a different communication device of communication system 3300. The host computer 3310 further comprises processing circuitry 3318, which may have storage and/or processing capabilities. In particular, the processing circuitry 3318 may comprise one or more programmable processors, ASICs, field programmable gate arrays (FPGA) or combinations of these (not shown) adapted to execute instructions. The host computer 3310 further comprises software 3311, which is stored in or accessible by host computer 3310 and executable by the processing circuitry 3318. The software 3311 comprises a host application 3312. The host application 3312 may be operable to provide a service to a remote user, such as UE 3330 connecting via OTT connection 3350 terminating at UE 3330 and host computer 3310. In providing the service to the remote user, the host application 3312 may provide user data which is transmitted using OTT connection 3350.

The communication network 3300 further comprises the network node 101 exemplified in FIG. 10 as a base station 3320 provided in a telecommunication system and comprising hardware 3325 enabling it to communicate with host computer 3310 and with UE 3330. The hardware 3325 may comprise a communication interface 3326 for setting up and maintaining a wired or wireless connection with an interface of a different communication device of the communication system 3300, as well as a radio interface 3327 for setting up and maintaining at least a wireless connection 3370 with the UE 103, exemplified in FIG. 10 as a UE 3330 located in a coverage area (not shown in FIG. 10) served by the base station 3320. The communication interface 3326 may be configured to facilitate the connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further comprises a processing circuitry 3328, which may comprise one or more programmable processors, ASICs, FPGAs or combinations of these (not shown) adapted to execute instructions. The base station 3320 further has software 3321 stored internally or accessible via an external connection.

The communication system 3300 further comprises a UE 3330 already referred to. It's hardware 3335 may comprise a radio interface 3337 configured to set up and maintain a wireless connection 3370 with a base station serving a coverage area in which the UE 3330 is currently located. The hardware 3335 of the UE 3330 further comprises a processing circuitry 3338, which may comprise one or more programmable processors, ASICs, FPGAs or combinations of these (not shown) adapted to execute instructions. The UE 3330 further comprises a software 3331, which is stored in or accessible by the UE 3330 and executable by the processing circuitry 3338. The software 3331 comprises a client application 3332. The client application 3332 may be operable to provide a service to a human or non-human user via the UE 3330, with the support of the host computer 3310. In the host computer 3310, an executing host application 3312 may communicate with the executing client application 3332 via an OTT connection 3350 terminating at the UE 3330 and the host computer 3310. In providing the service to the user, the client application 3332 may receive and request data from the host application 3312 and provide user data in response to the request data. The OTT connection 3350 may transfer both the request data and the user data. The client application 3332 may interact with the user to generate the user data that it provides.

It is noted that the host computer 3310, the base station 3320 and the UE 3330 illustrated in FIG. 10 may be similar or identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the UE 3330 via the base station 3320, without explicit reference to any intermediary devices and the precise routing of messages via these devices. The network infrastructure may determine the routing, which it may be configured to hide from the UE 3330 or from the service provider operating host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the spectrum efficiency and latency, and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and the UE 3330, in response to variations in the measurement results. The measurement procedure and/or the network functionality for reconfiguring the OTT connection 3350 may be implemented in the software 3311 and the hardware 3315 of the host computer 3310 or in the software 3331 and the hardware 3335 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which the software 3311, 3331 may compute or estimate the monitored quantities. The reconfiguring of the OTT connection 3350 may comprise information indicating message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer 3310's measurements of throughput, propagation times, latency and the like. The measurements may be implemented in that software 3311 and 3331 causes messages to be transmitted, in particular empty or ‘dummy’ messages, using the OTT connection 3350 while it monitors propagation times, errors etc.

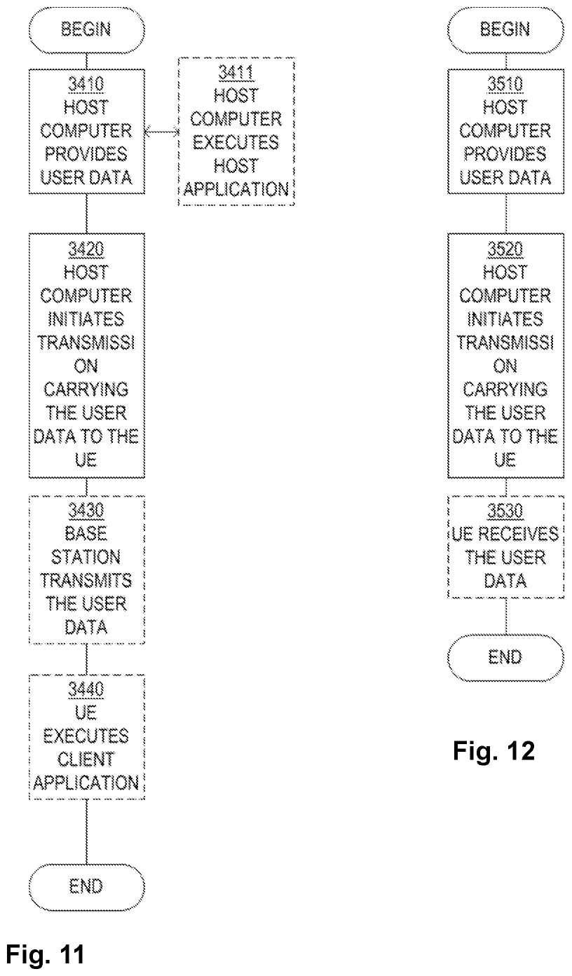

FIG. 11 illustrates an example of methods implemented in a communication system comprising a host computer, a base station and a UE. FIG. 11 is a flowchart illustrating a method implemented in a communication system. The communications network 100 comprises a host computer, a base station and a UE which may be those described with reference to FIG. 9 and FIG. 10. For simplicity of the present disclosure, only drawing references to FIG. 11 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 12 illustrates methods implemented in a communications network 100 comprising a host computer, a base station and a UE in accordance with some embodiments. FIG. 12 is a flowchart illustrating a method implemented in a communication network 100. The communications network 100 comprises a host computer, a base station and a UE which may be those described with reference to FIG. 9 and FIG. 10. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

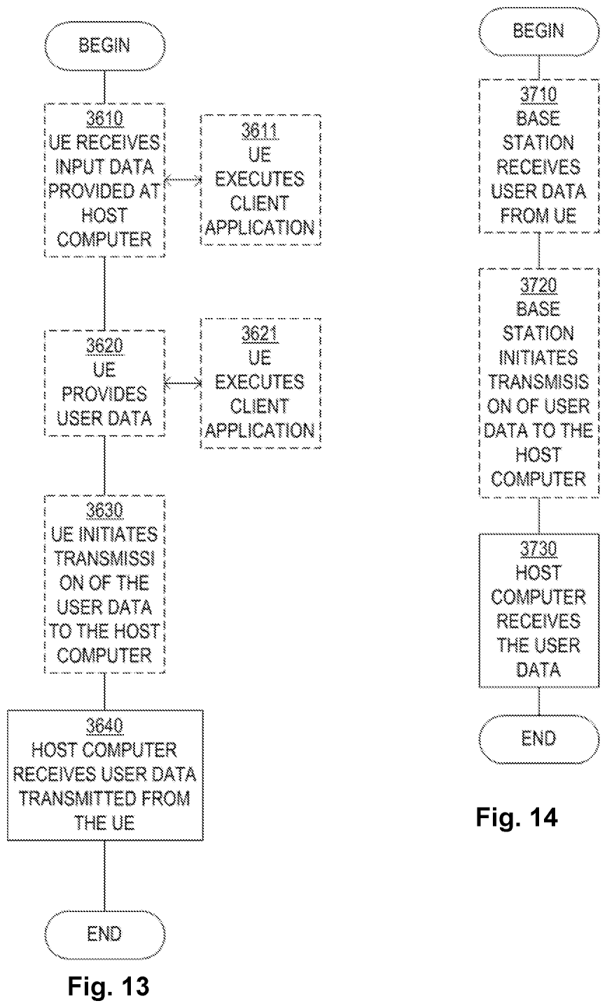

FIG. 13 illustrates methods implemented in a communications network 100 comprising a host computer, a base station and a UE. FIG. 13 is a flowchart illustrating a method implemented in a communications network 100. The communications network 100 comprises a host computer, a network node 101 and a UE 103 which may be those described with reference to FIG. 9 and FIG. 10. For simplicity of the present disclosure, only drawing references to FIG. 13 will be included in this section. In step 3610 (which may be optional), the UE 103 receives input data provided by the host computer. Additionally or alternatively, in step 3620, the UE 103 provides user data. In substep 3621 (which may be optional) of step 3620, the UE 103 provides the user data by executing a client application. In substep 3611 (which may be optional) of step 3610, the UE 103 executes a client application which provides the user data in reaction to the received input data provided by the host computer. In providing the user data, the executed client application may further consider user input received from the user. Regardless of the specific manner in which the user data was provided, the UE 103 initiates, in substep 3630 (which may be optional), transmission of the user data to the host computer. In step 3640 of the method, the host computer receives the user data transmitted from the UE 103, in accordance with the teachings of the embodiments described throughout this disclosure.

FIG. 14 illustrates methods implemented in a communications network 100 comprising a host computer, a base station and a UE 103. FIG. 14 is a flowchart illustrating a method implemented in a communication network 100. The communications network 100 comprises a host computer, a base station and a UE 103 which may be those described with reference to FIG. 9 and FIG. 10. In step 3710 (which may be optional), in accordance with the teachings of the embodiments described throughout this disclosure, the base station receives user data from the UE 103. In step 3720 (which may be optional), the base station initiates transmission of the received user data to the host computer. In step 3730 (which may be optional), the host computer receives the user data carried in the transmission initiated by the base station.

Some embodiments may be summarized as follows:

A network node 101 configured to communicate with a UE 103, the network node 101 comprising a radio interface and a processing circuitry configured to perform one or more of the actions described herein as performed by the network node 101.

A communications network 100 comprising a host computer comprising:
A processing circuitry configured to provide user data; and
a communication interface configured to forward the user data to a cellular network for transmission to a UE 103,
wherein the cellular network comprises a network node 101 having a radio interface and a processing circuitry, the base station's processing circuitry may be configured to perform one or more of the actions described herein as performed by the network node 101.

The communications network 100 may further comprise the network node 101.

The communications network 100 may further comprise the UE 103, wherein the UE 103 is configured to communicate with the network node 101.

The communications network 100, wherein:
the processing circuitry of the host computer is configured to execute a host application, thereby providing the user data; and
the UE 103 comprises a processing circuitry configured to execute a client application associated with the host application.

A method implemented in a network node 101, comprising one or more of the actions described herein as performed by the network node 101.

A method implemented in a communications network 100 comprising a host computer, a base station and a UE 103, the method comprising:
at the host computer, providing user data; and
at the host computer, initiating a transmission carrying the user data to the UE 103 via a cellular network comprising the network node 101. The network node 101 performs one or more of the actions described herein as performed by the network node 101.

The method may further comprise:
at the network node 101, transmitting the user data.

The user data may be provided at the host computer by executing a host application, and the method may further comprise:
at the UE 103, executing a client application associated with the host application.

A UE 103 configured to communicate with a network node 101, the UE 103 comprising a radio interface and processing circuitry configured to perform one or more of the actions described herein as performed by the UE 103.

A communications network 100 comprising a host computer comprising:
a processing circuitry configured to provide user data; and
a communication interface configured to forward user data to a cellular network for transmission to a UE 103,
wherein the UE comprises a radio interface and a processing circuitry, the UE's processing circuitry configured to perform one or more of the actions described herein as performed by the UE 103.

The communications network 100 may further comprise the UE 103.

The communications network 100 further comprising a network node 101 configured to communicate with the UE 103.

The communications network 100, wherein:
the processing circuitry of the host computer is configured to execute a host application, thereby providing the user data; and
the UE's processing circuitry is configured to execute a client application associated with the host application.

A method implemented in a UE 103, comprising one or more of the actions described herein as performed by the UE 103.

A method implemented in a communications network 100 comprising a host computer, a network node 101 and a UE 103, the method comprising:
at the host computer, providing user data; and
at the host computer, initiating a transmission carrying the user data to the UE 103 via a cellular network comprising the base station, wherein the UE 103 performs one or more of the actions described herein as performed by the UE 103.

The method may further comprise:
at the UE 103, receiving the user data from the network node 101.

A UE 103 configured to communicate with a network node 101, the UE 103 comprising a radio interface and processing circuitry configured to perform one or more of the actions described herein as performed by the UE 103.

A communications network 100 comprising a host computer comprising:
a communication interface configured to receive user data originating from a transmission from a UE 103 to a network node 101,
wherein the UE 103 comprises a radio interface and processing circuitry, the UE's processing circuitry configured to perform one or more of the actions described herein as performed by the UE 103.

The communications network 100 may further comprise the UE 103.

The communications network 100 may further comprise the network node 101, wherein the network node 101 comprises a radio interface configured to communicate with the UE 103 and a communication interface configured to forward to the host computer the user data carried by a transmission from the UE 103 to the network node 101.

The communications network 100, wherein:
the processing circuitry of the host computer is configured to execute a host application; and
the UE's processing circuitry is configured to execute a client application associated with the host application, thereby providing the user data.

The communications network 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 103, comprising one or more of the actions described herein as performed by the UE 103.

The method may further comprise:
providing user data; and
forwarding the user data to a host computer via the transmission to the network node 101.

A method implemented in a communications network 100 comprising a host computer, a network node 101 and a UE 103, the method comprising:
at the host computer, receiving user data transmitted to the network node 101 from the UE 103, wherein the UE 103 performs one or more of the actions described herein as performed by the UE 103.

The method may further comprise:
at the UE 103, providing the user data to the network node 101.

The method may further comprise:
at the UE 103, executing a client application, thereby providing the user data to be transmitted; and
at the host computer, executing a host application associated with the client application.

The method may further comprise:
at the UE 103, executing a client application; and
at the UE 103, receiving input data to the client application, the input data being provided at the host computer by executing a host application associated with the client application,
the user data to be transmitted is provided by the client application in response to the input data.

A network node 101 may be configured to communicate with a UE 103, the network node 101 comprising a radio interface and processing circuitry configured to perform one or more of the actions described herein as performed by the network node 101.

A communications network 100 may comprise a host computer comprising a communication interface configured to receive user data originating from a transmission from a UE 103 to a network node 101. The network node 101 comprises a radio interface and processing circuitry. The network node's processing circuitry may be configured to perform one or more of the actions described herein as performed by the network node 101.

The communications network 100 may further comprise the network node 101.

The communications network 100 may further comprise the UE 103. The UE 103 is configured to communicate with the network node 101.

The communications network 100 wherein:
the processing circuitry of the host computer is configured to execute a host application;
the UE 103 is configured to execute a client application associated with the host application, thereby providing the user data to be received by the host computer.

A method implemented in a network node 101, comprising one or more of the actions described herein as performed by any of the network node 101.

A method implemented in a communications network 100 comprising a host computer, a network node 101 and a UE 103, the method comprising:
at the host computer, receiving, from the network node 101, user data originating from a transmission which the base station has received from the UE 103, wherein the UE 103 performs one or more of the actions described herein as performed by the UE 103.

The method may further comprise:
at the network node 101, receiving the user data from the UE 103.

The method may further comprise:
at the network node 101, initiating a transmission of the received user data to the host computer.

Some embodiments will be summarized below: The communications network 100 may be a 2G network, a 3G network, a 4G network, a 5G network, a 6G network or any other legacy, current of future network.

The network node 101 may be a base station, node B, eNB, gNB, MeNB, RNC, access node, radio access node etc.

The embodiments herein relate to 5G, 4G, false base station, system information, broadcast message, digital signature etc.

The embodiments herein relate to signing SI in shared networks.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments

The embodiments herein are not limited to the above described embodiments. Various alternatives, modifications and equivalents may be used. Therefore, the above embodiments should not be taken as limiting the scope of the embodiments. A feature from one embodiment may be combined with one or more features of any other embodiment.

The term “at least one of A and B” should be understood to mean “only A, only B, or both A and B.”, where A and B are any parameter, number, indication used herein etc. It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods may, without departing from the embodiments herein, be performed in another order than the order in which they appear herein.

### ABBREVIATIONS

### 3GPP 3^{rd} Generation Partnership Project

### 5G 5^{th} Generation

### 5GS 5G System

5GC 5G Core network

### AMF Access and Mobility Management Function

### CN Core Network

### DL Downlink

### eNB Evolved Node B

### E-UTRAN Evolved Universal Terrestrial Access Network

EPC Evolved Packet Core network

### gNB 5G Node B

### LTE Long-term Evolution

### MME Mobility Management Entity

NG The interface/reference point between the RAN and the CN in 5G/NR.
NG-C The control plane part of NG (between a gNB and an AMF).
NG-U The user plane part of NG (between a gNB and a UPF).

### NG-RAN Next Generation Radio Access Network

### NR New Radio

### RAN Radio Access Network

### RRC Radio Resource Control

### Rx Receive

S1 The interface/reference point between the RAN and the CN in LTE.
S1-C The control plane part of S1 (between an eNB and a MME).
S1-U The user plane part of S1 (between an eNB and a SGW).

### SGW Serving Gateway

### TS Technical Specification

### UE User Equipment

### UL Uplink

### UPF User Plane Function

X2 The interface/reference point between two eNBs.

### X2AP X2 Application Protocol

Xn The interface/reference point between two gNBs.

### XnAP Xn Application Protocol

1.-42. (canceled)

43. A method performed by a User Equipment (UE), for handling System Information (SI), the method comprising:
obtaining one or multiple public keys for SI signature verification, wherein each of the one or multiple public keys is associated with a validity area of an access network where the public key is valid;
obtaining a SI together with a SI signature from a network node covering a cell, wherein the SI comprises area identification information;
determining, based on the area identification information comprised in the SI, the validity area that the cell belongs to and the corresponding public key; and
verifying the SI signature using the determined corresponding public key.

44. The method according to claim 43, wherein the validity area is associated with one or more of: Tracking Area Codes (TAC), Cell IDs, Radio Access Network Area Codes (RACs), or Physical Cell IDs (PCIs).

45. The method according to claim 43, wherein the obtained one or multiple public keys are one or multiple updated public keys which are updated compared to previously obtained one or multiple public keys.

46. The method according to claim 43, when multiple public keys are obtained, and the multiple public keys are associated with a mobility pattern of the UE.

47. The method according to claim 43, wherein the one or multiple public keys are obtained by reception from a network node or obtained by being preconfigured in the UE.

48. The method according to claim 43, wherein the one or multiple public keys are obtained during handover of the UE from one network node to another network node.

49. The method according to claim 43, further comprising:
obtaining information indicating that at least one of the one or multiple public keys should be revoked; and
revoking the at least one of the one or multiple public keys.

50. A method performed by a network node for handling System Information (SI), the method comprising:
generating a SI signature for at least one cell in an access network, wherein generating the SI signature comprises generating the SI signature using a private key corresponding to a validity area that the at least one cell belongs to; and
providing, to a User Equipment (UE), the SI in a cell which the network node covers, together with the SI signature, wherein the SI comprises area identification information.

51. The method according to claim 50, further comprising providing a User Equipment (UE) with one or multiple public keys for SI signature verification, wherein each of the one or multiple public keys is associated with a validity area of an access network where the public key is valid.

52. The method according to claim 51, wherein the provided one or multiple public keys are one or multiple updated public keys which are updated compared to previously provided one or multiple public keys.

53. A User Equipment (UE) configured for handling System Information (SI), the UE comprising:
radio circuitry; and
processing circuitry configured to:
obtain one or multiple public keys for SI signature verification, wherein each of the one or multiple public keys is associated with a validity area of an access network where the public key is valid;
obtain a SI together with a SI signature from a network node covering a cell, wherein the SI comprises area identification information;
determine, based on the area identification information comprised in the SI, the validity area that the cell belongs to and the corresponding public key; and
verify the SI signature using the determined corresponding public key.

54. The UE according to claim 53, wherein the validity area is associated with one or more of: Tracking Area Codes (TAC), Cell IDs, Radio Access Network Area Codes (RACs), or Physical Cell IDs (PCIs).

55. The UE according to claim 53, wherein the obtained one or multiple public keys are one or multiple updated public keys which are updated compared to previously obtained one or multiple public keys.

56. A network node configured for handling System Information (SI), the network node comprising:
one or more processors and a memory, the memory containing instructions executable by the one or more processors whereby the network node is configured to:
generate a SI signature for at least one cell in an access network using a private key corresponding to a validity area that the at least one cell belongs to; and
provide, to a User Equipment (UE), the SI in a cell which the network node covers, together with the SI signature, wherein the SI comprises area identification information.

57. The network node according to claim 56, the memory containing instructions executable by the one or more processors whereby the network node is configured to provide the UE with one or multiple public keys for SI signature verification, wherein each of the one or multiple public keys is associated with a validity area of an access network where the public key is valid.

58. The network node according to claim 57, wherein the provided one or multiple public keys are one or multiple updated public keys which are updated compared to previously provided one or multiple public keys.
